(19) United States
(12) Patent Application Publication
(10) Pub. No.: US 2015/0360764 A1
(43) Pub. Date: Dec. 17, 2015

(54) Structual Assembly Joint

(71) Applicant: AIRBUS OPERATIONS LIMITED, Bristol (GB)

(72) Inventor: Jonathan G. EALES, Bristol (GB)

(21) Appl. No.: 14/763,230

(22) PCT Filed: Jan. 30, 2014
(86) PCT No.: PCT/GB2014/050242

§ 371 Date: Jul. 24, 2015

(30) Foreign Application Priority Data
Jan. 31, 2013 (GB) 1301766.0

(51) Int. Cl. B64C 1/06

(52) U.S. Cl. CPC B64C 1/06

(57) ABSTRACT

A structural assembly joint including a panel comprising a core sandwiched between a pair of planar sheets. A portion of the core is absent at an edge of the panel to define a space between the sheets at the panel edge. A lug projects from a structural component to be joined to the panel. The lug is received in the space between the sheets and secured in place between the or each sheet. The lug is formed integrally with the structural component. Also provided is a method of manufacturing such a structural assembly joint.

### INTRODUCTION

The present invention relates to a joint for a structural assembly. More particularly, it relates to a joint for use in a structural assembly that forms part of an aircraft wing. A box section for an aircraft wing, an aircraft wing including a joint for a structural assembly according to the invention, together with a method of forming an aircraft wing, is also disclosed.

### BACKGROUND

In conventional commercial aircraft wing design, it is common to use a structural box to carry the majority of the load developed by lift and other high load devices. An example of part of such a structural box 1 is illustrated in the perspective view of FIG. 1 from which it can be seen that it is built from a number of different sections including spars 2, ribs 3 and stringers 4, which form the main load-bearing structural components of the wing, with upper and lower wing covers forming an outer skin surface (only the lower wing cover 5 is shown in FIG. 1). In conventional wing structures, these various components may be bolted together. However, this requires significant expense in drilling holes, deburring, sealing and fitting of the nuts and bolts. The nuts and bolts also add significant weight to the structure. To avoid the disadvantages of bolt fastenings, components may instead be bonded together. Composite components may be co-cured or co-bonded together as one part, in addition to the secondary bonding fastening that is employed with metal structural components.

One problem with known wing structures which are bonded is the limited bond area available between the components to be secured together and, consequently, the strength of the bonded joint, unless significant complexity is added at the joint location such as inclusion of a large flat area at the base of an ‘L’ or ‘I’ section to act as a large bond surface area.

The present invention seeks to overcome or substantially alleviate at least some of the problems with conventional assemblies referred to above.

### SUMMARY OF THE INVENTION

According to the invention, there is provided a structural assembly joint including a panel comprising a core sandwiched between a pair of planar sheets, wherein a portion of the core is absent at an edge of the panel to define a space between the sheets at the panel edge, and a lug projecting from a structural component to be joined to the panel, the lug received in the space between the sheets and secured in place between the or each sheet, wherein the lug is formed integrally with the structural component.

The sheets may extend beyond the core at the panel edge to define the space. The space may be a groove formed along the panel edge. The lug may be co-cured with the structural component.

The lug may be bonded to the or each sheet and/or the core of the panel, and may be bonded to the panel core, and may be bonded to one or both of the planar sheets.

The panel may comprise a central sheet between a pair of planar cores, and a portion of each core may be absent at the panel edge to define a pair of spaces between the central sheet and the respective planar sheets, and a pair of spaced lugs may project from a structural component to be joined to the panel, the lugs received in the spaces between the central sheets and the planar sheets.

The or each lug may be retained within the or each space by being a mechanical interference fit therein.

At least one of the surfaces of the lug(s) and/or sheet(s) in contact with each other may include surface relief configured to enhance the lug being mechanically retained within the respective space. The surface relief may comprise projecting teeth.

The structural component may comprise a lamina layer provided across a surface thereof and across the projecting lug, and the laminar layer may comprise a composite material.

The structural component may comprise a panel member and the lug may be provided on a joint member, wherein the joint member may be provided on a surface of the panel member.

The laminar layer may extend over the panel member and the joint member. The joint member may be co-cured with the panel member. The laminar layer may be co-cured with the panel member and/or with the joint member.

The structural assembly may comprise an assembly for forming part of an aircraft, and may be part of aircraft wing. The structural component may comprise a wing cover. The or each lug may project from the wing cover.

The structural assembly may comprise a solid insert disposed within the space and in sealing contact with the adjacent surfaces of the planar sheets of the panel. The solid insert may comprise a resilient deformable material. The solid insert may comprise an elongate member that extends along the length of the panel edge. The solid insert may comprise an elongate bead or strip of material.

The present invention also provides a structural assembly joint including a panel comprising a core sandwiched between a pair of planar sheets, wherein a portion of the core is absent at an edge of the panel to define a space between the sheets at the panel edge, and a lug projecting from a structural component to be joined to the panel, the lug received in the space between the sheets and secured in place between the or each sheet, and a solid insert disposed within the space and in sealing contact with the adjacent surfaces of the planar sheets. Such a structural assembly may further comprise any of the features described above.

The present invention also provides a structural assembly joint including a panel comprising a core sandwiched between a pair of planar sheets, wherein a portion of the core is absent at an edge of the panel to define a space between the sheets at the panel edge, and a lug projecting from a structural component to be joined to the panel, the lug received in the space between the sheets and secured in place between the or each sheet, wherein a lamina layer is provided across a surface of the structural component and across the projecting lug.

The structural component may comprise a panel member and the lug may be provided on a joint member, wherein the joint member may be provided on a surface of the panel member. The laminar layer may extend over the panel member and the joint member. The joint member may be bonded, co-bonded or co-cured with the panel member. The laminar layer may be bonded, co-bonded or co-cured with the panel member and/or with the joint member.

The present invention also provides a method of joining first and second components of a structural assembly, wherein the first component comprises a panel comprising a core sandwiched between a pair of planar sheets, the method comprising providing a space between the sheets at an edge of the panel, providing a projecting lug on the second component and formed integrally with the second component, inserting the lug of the second component into the space in the panel edge and securing the lug in place between the or each sheet.

The method may comprise bonding the lug in place between the or each sheet and/or to the core of the panel.

The step of providing the space at the panel edge may comprise providing a portion of the core being is absent at an edge of the panel to define the space.

The panel may be formed with an undersize core to define the space in the panel edge.

The method may comprise providing a groove along the panel edge to receive the lug.

Providing the projecting lug integrally on the second component may comprise co-curing the lug with the second component.

The method may comprise manufacturing a structural box assembly for an aircraft comprising providing upper and lower wing covers as the second components with a plurality of projecting lugs, fitting spars and/or ribs as the first components to the upper and lower covers by the lugs being secured into grooves in the spar and/or rib edges, wherein the spaces between the planar sheets comprise said grooves, and bonding the upper and lower covers together to form the closed box assembly.

The lugs may be formed on joint members formed integrally with the upper and lower wing covers, and which may be co-cured with the upper and lower wing covers. Joint members for connecting the lower cover to the spars may be initially provided on the lower cover and then bonded to the spars.

One joint member for attachment to one spar may be initially provided on the lower cover and a joint member for connecting another spar to the lower cover may be initially bonded to the respective spar.

The ribs may be formed once the spars and wing covers are bonded in place by bringing rib face sheets together to bond to a rib core placed where the ribs are to be positioned in the structural assembly and bonding the face sheets to the lugs as part of the rib-forming process.

The laminar layer may be provided across a surface of the second component and across the lug.

A solid insert may be provided within the space and in sealing contact with the adjacent surfaces of the planar sheets of the panel.

### BRIEF DESCRIPTION OF THE DRAWINGS

FIG. 1 shows a perspective view of part of a prior art wing box structure for an aircraft;

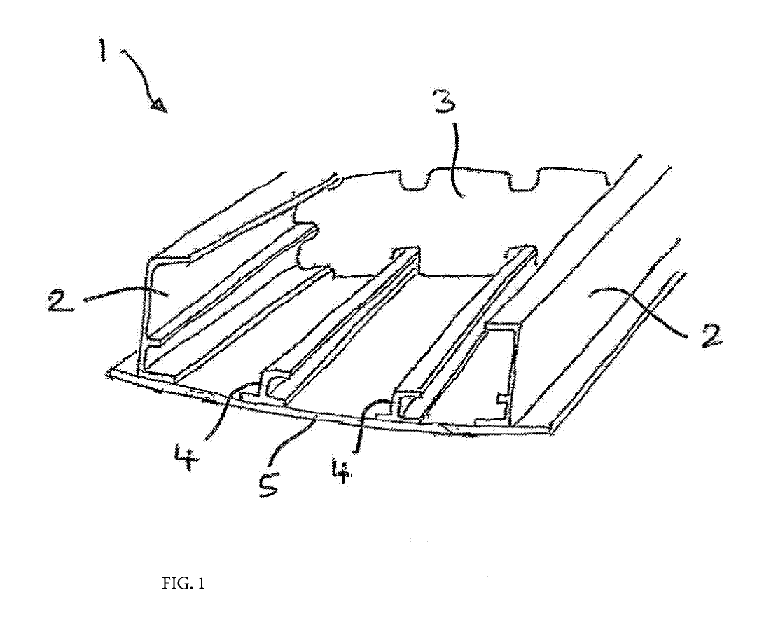

FIG. 2 shows a cross-sectional side view through a wing box structure for an aircraft;

FIG. 3 is an enlarged view showing part of the wing box structure shown in FIG. 2;

FIG. 4 shows a part of a wing box structure of an embodiment of the present invention;

FIG. 5 shows a part of a wing box structure of a second embodiment of the present invention;

FIG. 6 shows a part of a box wing structure of a third embodiment of the present invention; and

FIG. 7 shows a part of a box wing structure of a fourth embodiment of the present invention.

### DESCRIPTION OF THE EMBODIMENTS

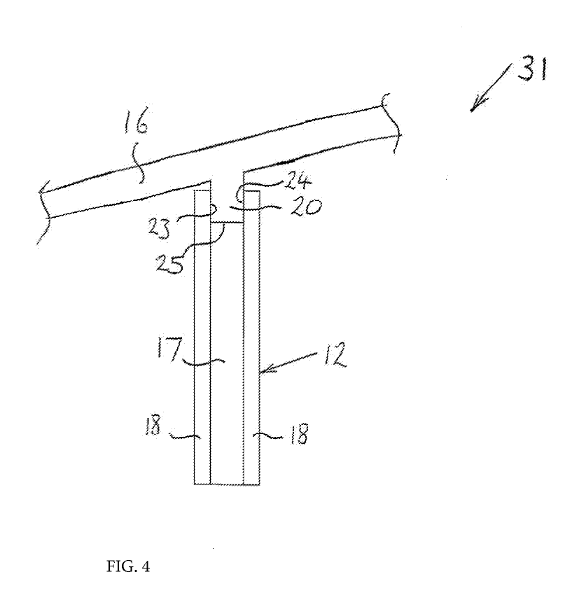

Embodiments of the invention will now be described, by way of example only, with reference to FIGS. 4 to 7 of the accompanying drawings.

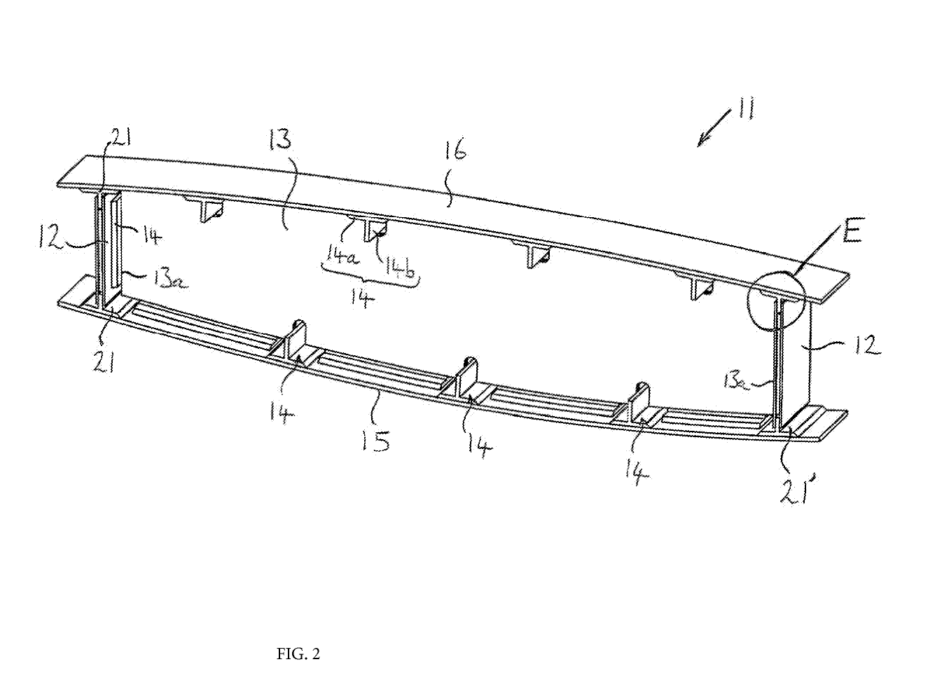

A wing box structure 11 shown in FIG. 2 comprises a plurality of components joined together, the components comprising a pair of spaced spars 12 with ribs 13 extending between the spars 12. Upper and lower covers 16, 15 are attached to the spars 12 and ribs 13 and comprise the wing outer skin. A plurality of stringers 14 are bonded to the upper and lower covers 16, 15 and extend transverse to the ribs 13 in a longitudinal direction of the wing.

The stringers 14 are generally T′ shaped in cross-section, with a foot portion 14a bonded to the surface of the upper and lower covers 16, 15 and a fin portion 14b upstanding from middle of the foot 14a. Although the stringers 14 are shown as being substantially ‘T’ shaped in cross-sectional profile, other profiles are also envisaged.

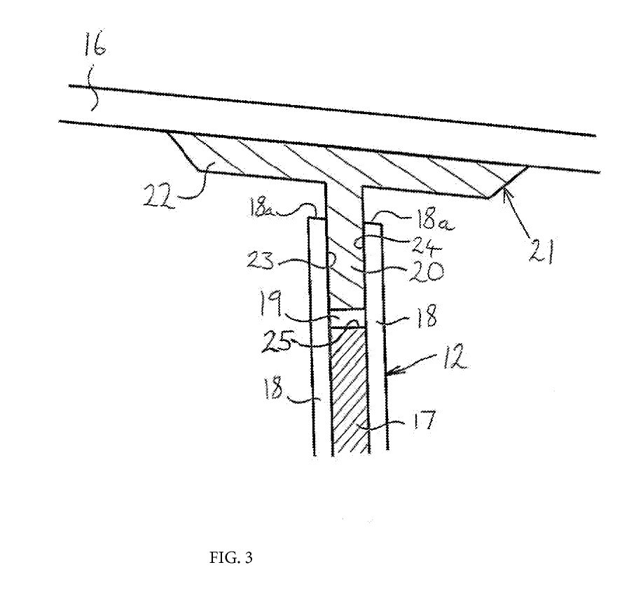

An enlarged view of a circled portion ‘E’ of the wing box structure 11 of FIG. 2 is shown in FIG. 3. The spars 12 and ribs 13 are planar sandwich panels which comprise a core 17 between a pair of spaced parallel planar face skins or face sheets 18 which are bonded to the core 17. The core 17 is undersized relative to the sheets 18, that is, the core 17 does not extend to the edges 18a of the sheets 18 along at least one side of the sandwich panel. This results in a square channel or groove 19 formed at the edge(s) of the sandwich panels. The spars 12 and ribs 13 are configured with these grooves 19 along their edges which are to be joined to the upper and lower covers 16, 15. Also, the edges of the ribs 13 which are to be joined to a side face of the spars 12 are also formed with such a groove 19.

The upper and lower covers 16, 15 include projecting lugs 20 which extend perpendicularly from their surface where the spars 12 and ribs 13 are to be joined. In the embodiment shown in FIGS. 2 and 3, the lugs 20 are part of a joint member 21 comprising a flat base 22 from which the lugs 20 upstand. Each joint member 21 may be bonded to the upper and lower covers 16, 15 by the flat base 22 being bonded thereto.

The spars 12 and ribs 13 are joined to the upper and lower covers 16, 15 by the relevant lug 20 being inserted into the groove 19 along the spar 12/rib 13 edge and bonded in place. This creates a double lap joint in which the sheets 18 of each sandwich panel component lie on either side of each lug 20, and provide an increased surface area over which a bond may be formed—namely the two side faces 23, 24 and bottom face 25 of the square groove 19. For maximum strength, the bond is formed over both inner side faces 23, 24 and bottom face 25 of the groove 19. However, the bond may be formed over only one or two of these faces 23, 24, 25. The configuration of the lug 20 and groove 19 joint also has inherent mechanical strength as any relative lateral movement at the joint is prevented by virtue of the interconnection of the lug 20 and groove 19, irrespective of the bond at the one or more groove inner faces 23, 24, 25.

The distal ends 13a of the ribs 13 also include grooves 19 and are joined to the respective adjacent side face of the spars 12 by a lug 20 of a joint member 21 on the spar side faces being received and bonded in the rib end 13a grooves 19, in the same manner as described above.

In a method of manufacturing a structural assembly, such as that described above and shown in FIGS. 2-3, firstly, the upper and lower covers 16, 15 are provided with the stringers 14 and the joint members 21 for attaching the spars 12 to the upper and lower covers 16, 15. The joint members 21 and/or stringers 14 are formed and cured independently of the upper and lower covers 16, 15 and are subsequently bonded to the upper and lower covers 16, 15. The spars 12 may then be fitted to the upper cover 16 by the respective lug 20 being bonded into the corresponding groove 19 in the spar 12 edge. The joint members 21 for attaching the ribs 13 to the upper and lower covers 16, 15 are then bonded to the inside surfaces of the upper and lower covers 16, 15. Similarly, the joint members 21 for attaching the ribs 13 to the inside faces of the spars 12 are then bonded to the inside surfaces of the spars 12.

The ribs 13 may then be slid onto the lugs 20 of the joint members 21 on the upper cover 16 and spars 12 and bonded in place. Finally, the lower cover 15 may be brought up so that the lugs 20 of the joint members 21 on the lower cover 15 are received in the grooves in the spars 12 and ribs 13 and bonded in place, thereby closing the box section of the structural assembly 11. In this step, both joint members 21 for connecting the lower cover 15 to the spars 12 may be initially provided on the lower cover 15 and then bonded to the spars 12. Alternatively, one joint member 21 for attachment to one spar 12 may already be bonded to the lower cover 15 and the joint member for connecting the other spar 12 to the lower cover 15, may be initially bonded to the respective spar 12. Then, as the lower cover 15 is brought into place, one lug 20 is bonded into the groove 19 of one spar 12, and the joint member 21 already bonded to the other spar 12 is then bonded to the lower cover 16.

In an alternative method to that described above, one of the joint members 21′ (see FIG. 2) for connecting one of the spars 12 to the one of the upper/lower covers 16, 15 may initially be omitted and may be bonded in place later as a final construction step to allow for chord-wise tolerances in the covers 16, 15. That joint member 21 may be bonded to the respective spar 12 initially and only later bonded to the respective cover 16, 15.

As a further alternative to the method described above, the rib 13 insertion step may be altered. The ribs 13 may not be prefabricated sandwich panel components. Instead, once the joint members 21 are provided on the upper cover 16 and spars 12, joint members 21 for connection to the lower cover 15 and to receive the ribs 13, may be held in place in a jig and the ribs formed by bringing the face sheets 18 in to bond to a core 17 placed where the ribs 13 are to be positioned in the structural assembly 11. The face sheets 18 would then bond to the lugs 20 as part of the rib-forming process.

The present invention provides a method of manufacturing a structural assembly such as that described above and shown in FIGS. 2 and 3, and may comprise the method of manufacturing as described above. In the method of the invention, the lug 20 is formed integrally with the upper/lower cover 16, 15 as a single component (described in more detail below with reference to FIGS. 4 to 7. More generally, the present invention provides a method of joining two components of a structural assembly together, which may, for example, be a cover 15 and spar 12 of an aircraft box section. An exemplary method of the invention involves providing the cover 15 with a protruding lug 20 on its surface where the spar 12 is to be joined to the cover 15. The spar 12 is a sandwich panel component with a groove 19 formed along at least one edge. The groove 19 may be formed by the core 17 not extending to the outer edges 18a of the face sheets 18 of the panel. The spar 12 is then fitted to the cover 15 by insertion of the lug 20 into the groove 19 along the edge of the spar 12 and being bonded in place. As mentioned above, in the method of the invention, the lug 20 is formed integrally with the cover 15, and may be formed integrally by being co-cured with the cover 15 as part of a joint member 21.

The configuration of the joint described above is advantageous as it only requires a single lug 20 or ridge to be formed on one surface of a component of the structural assembly. Another advantage is that the groove 19 can be easily created using the inherent construction of the sandwich panels—i.e. the panels comprise outer face sheets 18 either side of a core 17 and so making an undersized core 17 results in the required grooves 19. This single-lug/sandwich panel groove configuration is simple and therefore efficient and cost effective to manufacture. It will be appreciated that the grooves 19 may alternatively be formed in the sandwich panels by reaming or milling out the core material from a conventionally-formed panel having no edge grooves.

FIG. 4 shows an enlarged view of a part of a wing box structure 31 showing a structural assembly joint of an embodiment of the invention, and is a similar view to that of FIG. 3. Like features between the wing box structures retain the same reference numerals and will not be described again. One difference between the joint of the embodiment shown in FIG. 4, and that of FIGS. 2 and 3, is that the lug 20 is not formed on a joint member 21 which is bonded to the upper/lower cover 16, 15, but instead the lug 20 is formed integrally with the upper/lower cover 16, 15 as a single component. Otherwise, the rest of the construction, technical detail and advantages of the joint of the first embodiment are the same as those of the previously described embodiment and so will not be described again. The lug being formed integrally with the upper/lower cover provides the lug with increased strength and so the assembled wing box structure 31 is able to withstand greater load forces, especially in the lateral direction.

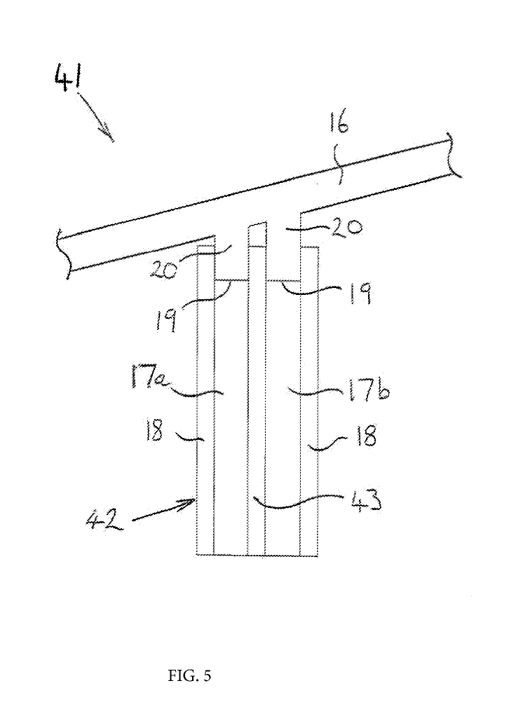

FIG. 5 shows an enlarged view of a part of a wing box structure 41 showing a structural assembly joint of a second embodiment of the invention, and is a similar view to that of FIG. 4, and like features retain the same reference numerals. One difference between the joint of the second embodiment and that of the first embodiment is that the upper cover 16 is formed with two lugs 20 adjacent one another, instead of just one. Furthermore, a planar structural component, such as a spar 42, which is attached to the upper cover 16, is of a double-sandwich panel configuration. That is, the spar 42 comprises outer face sheets 18, between which are disposed first and second planar cores 17a, 17b, and between the first and second cores 17a, 17b is disposed a middle sheet 43. A groove 19 is formed between the middle sheet 43 and each outer face sheet 18 where the first and second cores 17a, 17b are respectively absent along the panel edge. These grooves can be formed in any manner, or result from any process, as described previously in respect of the first and second embodiments.

To secure the spar 42 to the upper cover 16, the two lugs 20 are respectively received in the adjacent parallel grooves 19, and bonded in place. This second embodiment provides additional strength to the joint, both laterally by the increased number of abutting layers of face/middle sheets 18, 43 against the two lugs 20, but also longitudinally of the lugs 20 due to the increased surface area over which the spar 42 and upper cover 16 are bonded together. Again, the two grooves 19 can be easily created using the inherent construction of the sandwich panel—i.e. the panel comprises outer face sheets 18 either side of a first and second cores 17a, 17b, which themselves sandwich the middle sheet 43 and so, for example, making undersized cores 17a, 17b, results in the required grooves 19. The two lugs 20 are formed integrally with the upper cover 16, and may be co-cured with the upper cover 16.

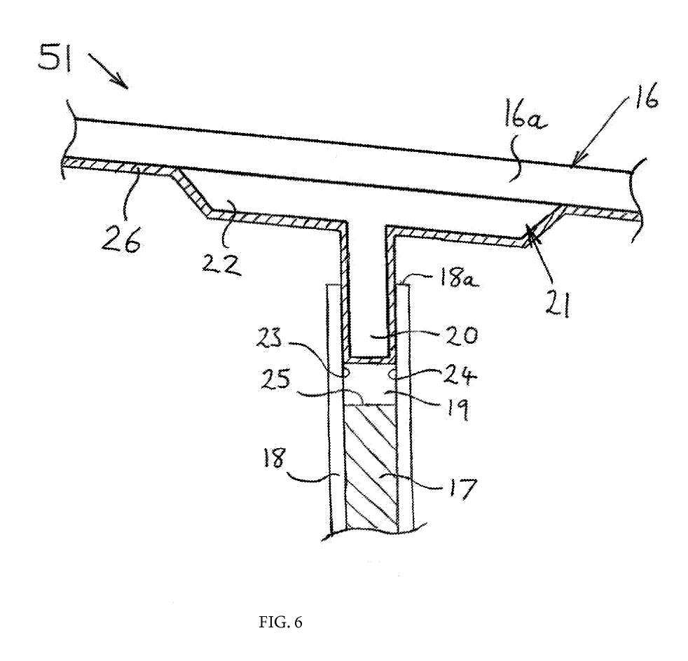

FIG. 6 shows an enlarged view of a part of a wing box structure 51 showing a structural assembly joint of a third embodiment of the invention. Like features of the previously-described wing box structures retain the same reference numerals and description thereof will not be repeated.

A difference between the wing box structure of the third embodiment of the invention and the previous embodiments is that the upper and lower covers 16, 15 are of an alternative construction and comprise an alternative configuration of integrally-formed projecting lug 20 to the configuration of the first and second embodiments. In the third embodiment, the upper and lower covers 16, 15 comprise a generally planar panel 16a with projecting lugs 20 extending perpendicularly from joint members 21 on their inner surface. The inner surface is provided with a laminate layer 26 over the inner surface of the planar panel 16a and over the joint member 21, thereby forming an upper/lower cover component with integrally formed projecting lugs 20. Each joint member 21 may be bonded to, or co-bonded or co-cured with, the planar panel section 16a of the upper or lower cover 16, 15. The laminate layer 26 may be bonded to, co-bonded or co-cured with the planar panel 16a and/or joint members 21. The laminate layer 26 may comprise composite material and/or may comprise a plurality of laminations extending across the planar panel and joint members/lugs. As with the first and second embodiments of the invention, the lugs 20 being formed integrally with the upper/lower covers provides the lug with increased strength and so the assembled wing box structure 31 is able to withstand greater load forces, especially in the lateral direction.

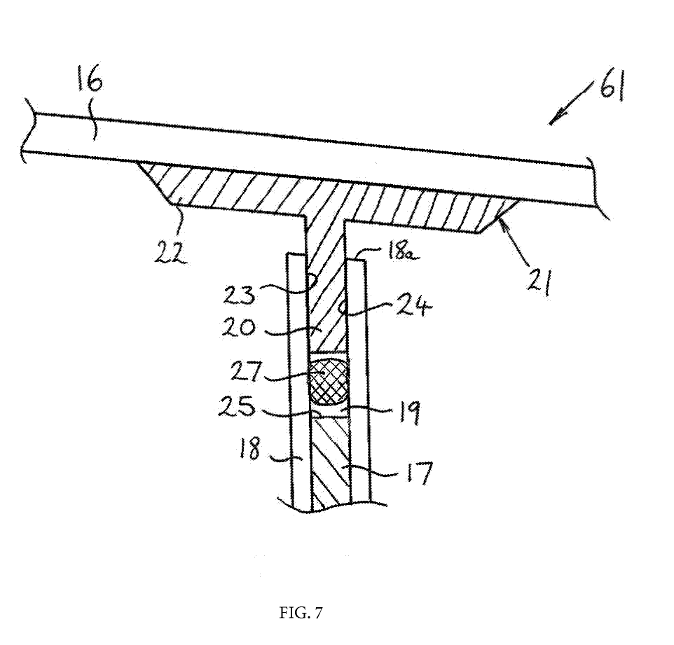

FIG. 7 shows an enlarged view of a part of a wing box structure 61 showing a structural assembly joint of a fourth embodiment of the invention. Like features of the previously-described wing box structures retain the same reference numerals and description thereof will not be repeated.

The configuration of the wing box structure 61 of the fourth embodiment is similar to that shown in FIGS. 2 and 3 and described above, and so like features retain the same reference numerals and description thereof will not be repeated. A difference in the fourth embodiment 61 is that a solid insert 27 is disposed within the groove 19 formed at the edge of the sandwich panel, so as to be positioned between the distal end of the lug 20 and the exposed portion of the core 17 of the sandwich panel that forms the bottom face 25 of the groove 19. The solid insert 27 is preferably a resilient member and may be made of rubber, plastic or other material with a degree of deformability. The insert 27 advantageously provides a seal between the inside surfaces of the sheets 18 that form the side faces 23, 24 of the groove 19, preventing ingress of moisture into the groove 19 beyond the insert 27. This is advantageous as it seals the exposed portion of the core 17 of the sandwich panel that forms the bottom face 25 of the groove 19 from ambient moisture. The core 17 of the sandwich panels is often a material of lower density and may be of a porous structure, so ingress of moisture to the core 17 could be absorbed by the core 17 and/or significantly weaken the structure of the sandwich panel and thereby the overall wing box structure 61.

The solid insert 27 may be bonded in place within the groove 19 by a suitable adhesive, or may be held in place by friction by having been deformed to be inserted into the groove 19. The insert 27 may be provided as an elongate length of material to be fitted into the groove 19 along the length of the sandwich panel. The insert 27 may be provided as a continuous length of material that is cut to size to fit within each elongate groove 19 as required.

Although the solid insert 27 is shown in FIG. 7 as being applied to a wing box structure similar to that shown in FIGS. 2 and 3, the solid insert 27 arrangement of the fourth embodiment of the invention could equally be applicable to, and provided in conjunction with, wing box structures 31, 41, 51 of the first to third embodiment of the invention shown in FIGS. 4 to 6 respectively.

The structural assembly joints of the invention have been described herein in the context of joining components of a box section of an aircraft wing. However, it will be appreciated that the structural assembly joints of the invention may be used in many other applications such as automotive vehicles, spacecraft, satellites, or other aircraft types and structures.

The embodiments of structural assembly joints of the invention are described above as the lugs 20 being bonded into the respective grooves 19. However, the invention is not intended to be limited to this specific configuration and alternative securing means are envisaged within the scope of the invention. For example, the lugs 20 and grooves may be so dimensioned that the lugs make a frictional fit in the grooves and are thereby held in place by mechanical interference. Also, the respective surfaces of the lugs 20 and/or grooves may be configured to promote securing in place, with or without bonding/adhesive. For example, the lug and/or groove surfaces in contact could be provided with frictional enhancing surface relief, such as ridges, teeth, protrusions or recesses. Yet further, with or without bonding/adhesive at the lug/groove interface, additional securing means may be provided, such as bolts, pins or rivets, extending through the face sheets 18 and lugs 20.

It will be appreciated that the foregoing description is given by way of example only and that modifications may be made to the support assembly of the present invention without departing from the scope of the appended claims.

1. A structural assembly joint including a panel comprising a core sandwiched between a pair of planar sheets, wherein a portion of the core is absent at an edge of the panel to define a space between the sheets at the panel edge, and a lug projecting from a structural component to be joined to the panel, the lug received in the space between the sheets and secured in place between the or each sheet, wherein the lug is formed integrally with the structural component.

2. A structural assembly according to claim 1 wherein the sheets extend beyond the core at the panel edge to define the space.

3. A structural assembly according to claim 1 wherein the space is a groove formed along the panel edge.

4. A structural assembly according to claim 1 wherein the lug is co-cured with the structural component.

5. A structural assembly according to claim 1 wherein the lug is bonded to the or each sheet and/or the core of the panel.

6. A structural assembly according to claim 5 wherein the lug is bonded to the panel core.

7. A structural assembly according to claim 5 wherein the lug is bonded to one or both of the planar sheets.

8. A structural assembly according to claim 1 wherein the panel comprises a central sheet between a pair of planar cores, and a portion of each core is absent at the panel edge to define a pair of spaces between the central sheet and the respective planar sheets, and wherein pair of spaced lugs project from a structural component to be joined to the panel, the lugs are received in the spaces between the central sheets and the planar sheets.

9. A structural assembly according to claim 1 wherein the or each lug is retained within the or each space by being a mechanical interference fit therein.

10. A structural assembly according to claim 1 wherein at least one of the surfaces of the lug(s) and/or sheet(s) in contact with each other include surface relief configured to enhance the lug being mechanically retained within the respective space.

11. A structural assembly according to claim 10 wherein the surface relief comprises projecting teeth.

12. A structural assembly according to claim 1 wherein the structural component comprises a lamina layer provided across a surface thereof and across the projecting lug.

13. A structural assembly according to claim 12 wherein the laminar layer comprises a composite material.

14. A structural assembly according to claim 12 wherein the structural component comprises a panel member and the lug is provided on a joint member, the joint member being provided on a surface of the panel member, and wherein the laminar layer extends over the panel member and the joint member.

15. A structural assembly according to claim 14 wherein the joint member is co-cured with the panel member.

16. A structural assembly according to claim 14 wherein the laminar layer is co-cured with the panel member and/or with the joint member.

17. A structural assembly according to claim 1 comprising an assembly for forming part of an aircraft.

18. A structural assembly according to claim 1 further comprising a solid insert disposed within the space and in sealing contact with the adjacent surfaces of the planar sheets of the panel.

19. A structural assembly according to claim 18 wherein the solid insert comprises a resilient deformable material.

20. A structural assembly according to claim 18 wherein the solid insert comprises an elongate member that extends along the length of the panel edge.

21. A structural assembly joint including a panel comprising a core sandwiched between a pair of planar sheets, wherein a portion of the core is absent at an edge of the panel to define a space between the sheets at the panel edge, and a lug projecting from a structural component to be joined to the panel, the lug received in the space between the sheets and secured in place between the or each sheet, and a solid insert disposed within the space and in sealing contact with the adjacent surfaces of the planar sheets.

22. (canceled)

23. A method of joining first and second components of a structural assembly, wherein the first component comprises a panel comprising a core sandwiched between a pair of planar sheets, the method comprising providing a space between the sheets at an edge of the panel, providing a projecting lug on the second component and formed integrally with the second component, inserting the lug of the second component into the space in the panel edge and securing the lug in place between the or each sheet.

24. A method according to claim 23 comprising bonding the lug in place between the or each sheet and/or to the core of the panel.

25. A method according to claim 24 wherein the step of providing the space at the panel edge comprises providing a portion of the core being is absent at an edge of the panel to define the space.

26. A method according to claim 25 wherein the panel is formed with an undersize core to define the space in the panel edge.

27. A method according to claim 23 comprising providing a groove along the panel edge to receive the lug.

28. A method according to claim 23 wherein the method comprises manufacturing a structural box assembly for an aircraft comprising providing upper and lower wing covers as the second components with a plurality of projecting lugs, fitting spars and/or ribs as the first components to the upper and lower covers by the lugs being secured into grooves in the spar and/or rib edges, wherein the spaces between the planar sheets comprise said grooves, and bonding the upper and lower covers together to form the closed box assembly.

29. A method according to claim 28 wherein the lugs are formed on joint members formed integrally with the upper and lower wing covers, and which may be co-cured with the upper and lower wing covers.

30. A method according to claim 29 wherein joint members for connecting the lower cover to the spars are initially provided on the lower cover and then bonded to the spars.

31. A method according to claim 29 wherein one joint member for attachment to one spar is initially provided on the lower cover and a joint member for connecting another spar to the lower cover is initially bonded to the respective spar.

32. A method according to claim 20 wherein the ribs are formed once the spars and wing covers are bonded in place by bringing rib face sheets together to bond to a rib core placed where the ribs are to be positioned in the structural assembly and bonding the face sheets to the lugs as part of the rib-forming process.

33. A method according to claim 23 further comprising providing a laminar layer across a surface of the second component and across the lug.

34. A method according to claim 23 further comprising providing a solid insert within the space and in sealing contact with the adjacent surfaces of the planar sheets of the panel.
